(19) United States
(12) Patent Application Publication
(10) Pub. No.: US 2009/0248647 A1
(43) Pub. Date: Oct. 1, 2009

(54) SYSTEM AND METHOD FOR THE QUALITY ASSESSMENT OF QUERIES

(76) Inventors: Omer Ziv, Rehovot (IL); Michael Brand, Parkdale (AU); Yitzhak Stauber, Ra'anna (IL); Ido Shapira, Tel Aviv (IL); Daniel Mark Baum, Modiin (IL); Yaron Gvili, Kfar Saba (IL)

Correspondence Address: SETTER ROCHE LLP, P.O. BOX 780, ERIE, CO, 80516, US

(21) Appl. No.: 12/055,102

(22) Filed: Mar. 25, 2008

(51) Int. Cl. G06F 17/30

(52) U.S. Cl. 707/4; 707/E17.062

(57) ABSTRACT

A computer system coupled to a database is configured to receive a database query, and evaluate a set of records from a database based on the database query. The database comprises a plurality of records, and each record comprises text translated from audio. The system then determines a plurality of measurement terms based on the database query, and processes at least a portion of the text of at least one record of the database to determine a quality of the database query based on the occurrences of the measurement terms within the portion of text, and performs an action based on the quality of the database query.

### TECHNICAL FIELD

This invention is related to the field of database queries, and more specifically to the quality assessment of database queries, where the database comprises a plurality of records, and the records comprise text translated from audio.

### TECHNICAL BACKGROUND

Operations such as call centers may generate large databases of records containing text translated from audio data. For example, a call center may record each call initiated or received by the call center for later analysis. Typically, these recordings are translated from audio data to text data for storage and retrieval as records in a database. Database queries are used to access sets of records from the database, based on one or more query terms within the database queries. However, when the query returns a set of records, users have no way of knowing if the set selected by the query contains all of the records that the user desires. A user would have to spend large amounts of time composing a variety of queries and comparing the results of the queries in order to find an optimum query for selecting the desired records.

### OVERVIEW

A computer system coupled to a database is configured to receive a database query, and evaluate a set of records from a database based on the database query. The database comprises a plurality of records, and each record comprises text translated from audio. The system then determines a plurality of measurement terms based on the database query, and processes at least a portion of the text of at least one record of the database to determine a quality of the database query based on the occurrences of the measurement terms within the portion of text, and performs an action based on the quality of the database query.

In some embodiments the measurement terms comprise terms from the database query. The measurement terms also may comprise synonyms, homophones, and alternate inflections of terms from the database query.

The computer system also may be configured to process at least a portion of the text of at least one record of the database by processing at least a portion of the text of at least one record of the database to determine the quality of the database query based on the location and frequency of the measurement terms alone and with respect to each other occurring within the text.

In some example embodiments at least one record includes a confidence score corresponding to the confidence of the translation of the portion of the text from audio to text.

The computer system also may be configured to process at least a portion of the text of at least one record of the database by processing at least a portion of the text of at least one record of the database to determine the quality of the database query based on the confidence score of the at least a portion of text.

The computer system may further be configured to process the set of records with the database query to determine a stability of the database query, and modify the quality of the database query based on the stability of the database query.

In some examples at least one record also contains metadata and the computer system is configured to process at least a portion of the metadata of at least one record of the database to determine a quality of the database query.

In still further embodiments the action includes modifying the database query, while in other embodiments the action includes suggesting modification of the database query to a user.

In still further embodiments, the computer is configured to evaluate a set of records from the database by determining a score for each record based on the occurrences of the measurement terms within each record.

In another embodiment, a computer system coupled to a database is configured to receive a database query, and evaluate a set of records from a database based on the database query. The database comprises a plurality of records, and each record comprises text translated from audio. The system also receives a tag from a user corresponding to at least one record within the database. The system then processes at least one of the records in the database to determine a quality of the database query based on the records corresponding to the tag, and performs an action based on the quality of the database query.

In yet another embodiment, a computer system coupled to a database is configured to receive a first database query, and evaluate a first set of records from a database based on the first database query. The database comprises a plurality of records, and each record comprises text translated from audio. The system also receives a second database query, and determines a plurality of second measurement terms based on the second database query. The computer system continues by processing at least a portion of the text of at least one record of the first set of records to determine a coupling of the first database query and the second database query based on the occurrences of the second measurement terms within the portion of the text of at least one record of the first set of records. Finally, the computer system performs an action based on the coupling of the first database query and the second database query.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a block diagram illustrating a system for the quality analysis of database queries;

FIG. 2 is block diagram illustrating a computer system configured for the quality analysis of database queries;

FIG. 3 is a flow diagram illustrating a method for the quality analysis of database queries;

FIG. 4 is a flow diagram illustrating a method for the quality analysis of database queries;

FIG. 5 is a flow diagram illustrating a method for the quality analysis of database queries;

FIG. 6 is an illustration of a user interface in a system for the quality analysis of database queries; and

FIG. 7 is a flow diagram illustrating a method for the quality analysis of database queries.

### DETAILED DESCRIPTION

As discussed above, when users compose database queries, there currently is no mechanism for evaluating the quality of the query. Queries may suffer from two different errors. Some queries may retrieve spurious records that the user does not desire to select, while other queries may fail to retrieve records that the user desires. Some queries may suffer from both of these errors. By determining the quality of a database query, users are able to make more intelligent decisions about any modifications of the query.

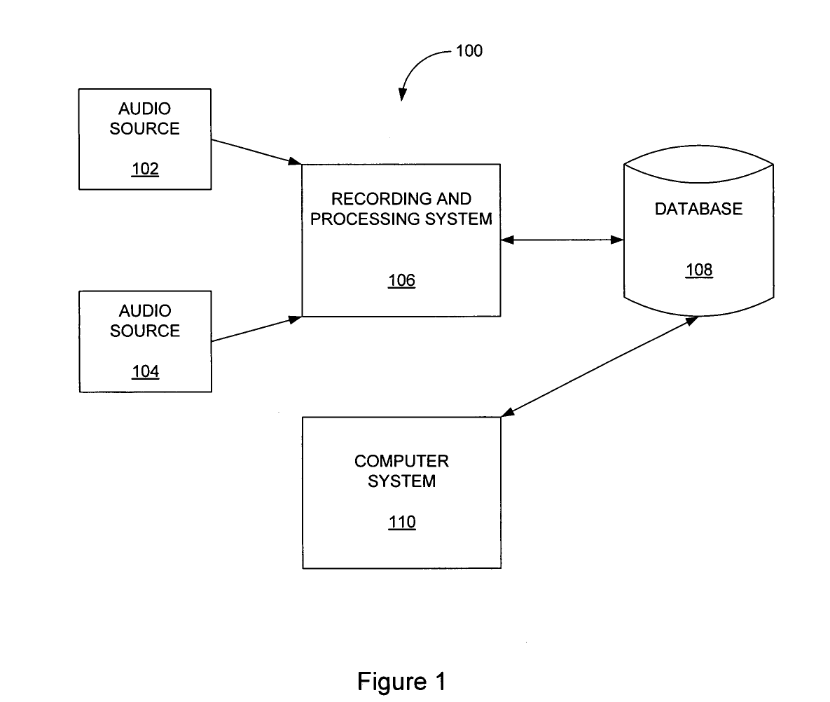

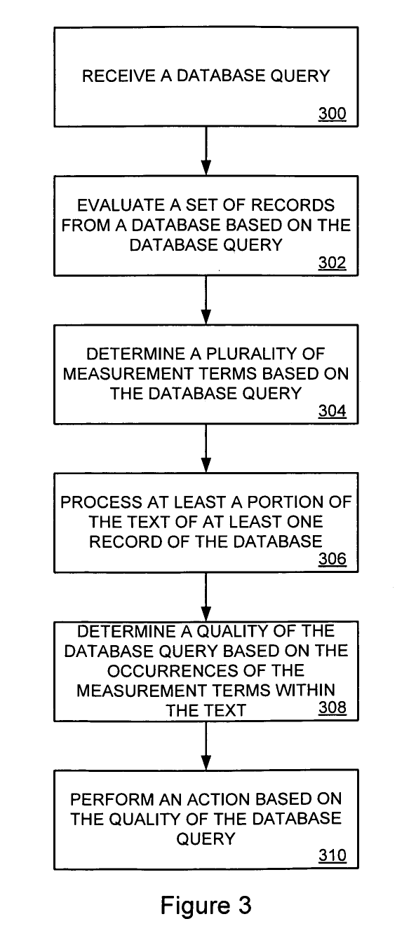

FIG. 1 is a block diagram illustrating a system for the quality analysis of database queries. This example audio system 100 includes audio source 102, audio source 104, recording and processing system 106, database 108, and computer system 110. Audio sources 102 and 104 are configured to send audio data to recording and processing system 106. This audio data may take any of a very wide variety of formats, including both analog and digital audio formats. Recording and processing system 106 receives audio data from audio sources 102 and 104, translates the audio data to text data, and stores the text data (in the format of records) in database 108. Recording and processing system 106 may optionally assign a confidence factor to each word translated from audio to text and store the confidence factors with the text data on database 108. Confidence factors are estimates of the accuracy of the translation of a word or phrase from audio data to text data. Computer system 110 is coupled with database 108 and is configured to perform searches and analysis of the text contained in records in database 108. This functionality is illustrated in FIGS. 3-7 and described in further detail below.

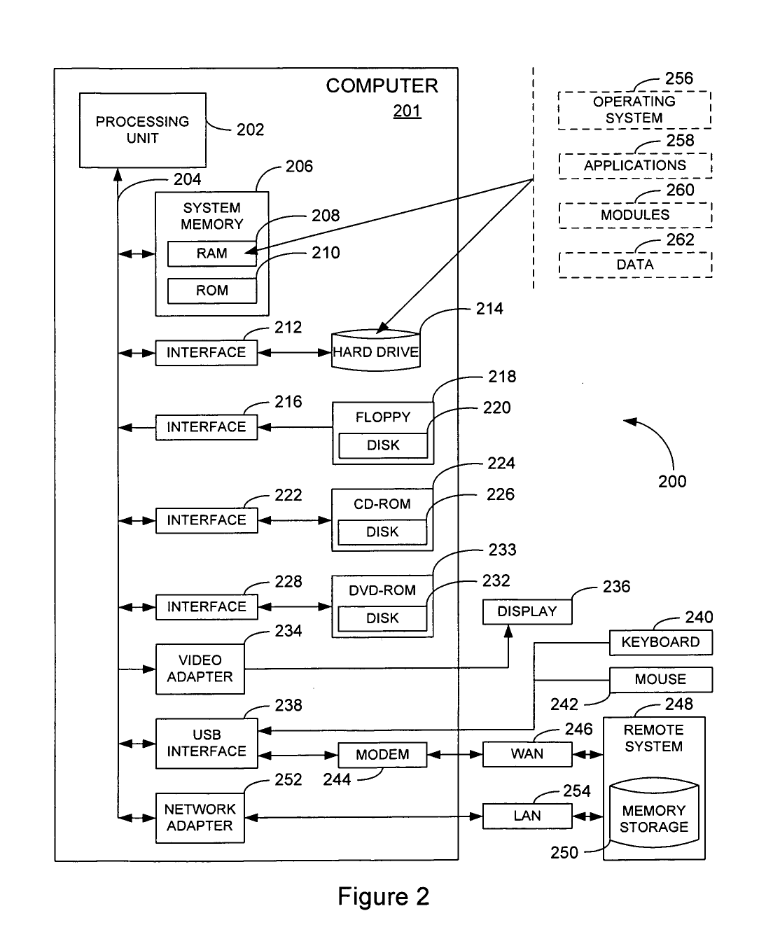

The methods, systems, devices, databases, and servers described herein may be implemented with, contain, or be executed by one or more computer systems. The methods described herein may also be stored on a computer readable medium. Many of the elements of audio system 100 may be, comprise, or include computer systems. This includes, but is not limited to audio source 102, audio source 104, recording and processing system 106, database 108, and computer system 110. These computer systems are illustrated, by way of example, in FIG. 2.

FIG. 2 is a block diagram illustrating a computer system 200 including a computer 201 configured as computer system 110, such as that illustrated in FIG. 1. Computer system 200 includes computer 201 which in turn includes processing unit 202, system memory 206, and system bus 204 that couples various system components including system memory 206 to processing unit 202. Processing unit 202 may be any of a wide variety of processors or logic circuits, including the Intel X86 series, Pentium, Itanium, and other devices from a wide variety of vendors. Processing unit 202 may include a single processor, a dual-core processor, a quad-core processor or any other configuration of processors, all within the scope of the present invention. Computer 201 could be comprised of a programmed general-purpose computer, although those skilled in the art will appreciate that programmable or special purpose circuitry and equipment may be used. Computer system 200 may be distributed among multiple devices that together comprise elements 202-262.

There are a wide variety of system bus 204 architectures, such as PCI, VESA, Microchannel, ISA, and EISA, available for use within computer 201, and in some embodiments multiple system buses may be used within computer 201. System memory 206 includes random access memory (RAM) 208, and read only memory (ROM) 210. System ROM 210 may include a basic input/output system (BIOS), which contains low-level routines used in transferring data between different elements within the computer, particularly during start-up of the computer. System memory 206 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, system memory 206 may incorporate electronic, magnetic, optical, and/or other types of storage media. Note that system memory 206 can have a distributed architecture, where various components are situated remote from one another, but can be accessed by processing unit 202.

Processing unit 202 receives software instructions from system memory 206 or other storage elements and executes these instructions directing processing unit 202 to operate in a method as described herein. These software instructions may include operating system 256, applications 258, modules 260, utilities, drivers, networking software, and data 262. Software may comprise firmware, or some other form of machine-readable processing instructions.

Computer 201 also includes hard drive 214 coupled to system bus 204 through hard drive interface 212, floppy drive 218 containing floppy disk 220 coupled to system bus 204 through floppy drive interface 216, CD-ROM drive 224 containing CD-ROM disk 226 coupled to system bus 204 through CD-ROM drive interface 222, and DVD-ROM drive 233 containing DVD-ROM disk 232 coupled to system bus 204 through DVD-ROM drive interface 228. There are a wide variety of other storage elements, such as flash memory cards and tape drives, available for inclusion in computer 201, which may be coupled to system bus 204 through a wide variety of interfaces. Also, these storage elements may be distributed among multiple devices, as shown here, and also may situated remote from each other, but can be accessed by processing unit 202.

Computer 201 also includes video adaptor 234 configured to drive display 236, and universal serial bus (USB) interface 238 configured to receive user inputs from keyboard 240 and mouse 242. Other user interfaces could comprise a voice recognition interface, microphone and speakers, graphical display, touch screen, game pad, scanner, printer, or some other type of user device. These user interfaces may be distributed among multiple user devices. USB interface 238 is also configured to interface with modem 244 allowing communication with remote system 248 through a wide area network (WAN) 246, such as the internet. USB interface 238 and network adaptor 252 may be configured to operate as input ports capable of receiving records from database 108, and audio data from audio sources 102 and 104.

Computer 201 further includes network adaptor 252 configured to communicate to remote system 248 through a local area network (LAN) 245. There are a wide variety of network adaptors 252 and network configurations available to allow communication with remote systems 248, and any may be used in other embodiments. For example, networks may include Ethernet connections or wireless connections. Networks may be local to a single office or site, or may be as broad and inclusive as the Internet or Usenet. Remote systems 248 may include memory storage 250 in a very wide variety of configurations.

FIG. 3 is a flow diagram illustrating a method for the quality analysis of database queries. Reference numbers from FIG. 3 are indicated parenthetically below. In this example, computer system 110 receives a database query, (operation 300). This database query may be received from a user, retrieved from memory or otherwise received by computer system 110. Each record in the database comprises text data translated from audio data, such as from calls recorded by a call center. Records may also include metadata, such as the date, time, and location of the call, the identities of the parties to the call, along with a wide variety of other information.

Database queries may include a wide variety of formats. For example, a query may comprise a plurality of database query terms such as “credit WITHIN 5 OF card” which would find all instances of the word “credit” appearing within 5 words of “card.” Terms may also include elements such as the time within the call where the word or words appear. For example, a term may be defined to search for a phrase, but limit the search to calls where the phrase only occurs in the first minute of the call. Query terms may also be weighted by their importance, or may be given negative weights as terms to avoid. In some embodiments, records containing “avoid” terms are removed from the set or records retrieved by the database query. Many complex terms may be formed and used within a database query. Also, a query may contain a list of tagged records that must be included in the results, or a list of tagged records that must not be included in the results.

Computer system 110 then evaluates a set of records from database 108 based on the database query, (operation 302). This evaluation may take a variety of forms. For example, computer system 110 may retrieve header information for each of the records, or it may retrieve each of the set of records for review by the user in addition to quality analysis as described below.

Computer system 110 determines a plurality of measurement terms based on the database query, (operation 304). These measurement terms may, in some examples, include terms from the database query. Other embodiments may include synonyms, homophones, and alternate inflections (such as verb conjugations) of terms from the database query. Also, they may comprise terms such as the identity of the speaker, time within the call, or other similar terms.

Computer system 110 then processes at least a portion of the text of at least one record of the database, (operation 306). This processing may include finding all the occurrences of a term within one or more records, or determining how many different measurement terms are found within each record, or any other similar processing of the records from database 108. This operation may optionally include processing of at least a portion of the metadata associated with the text of at least one record of the database. In some embodiments, computer system 110 determines a score for each record based on the occurrences of the measurement terms within each record. Other embodiments may determine the correlation between measurement terms by examining two or more different terms and determining if they occur in, or are absent from, the same subsets of records. In some embodiments, the text translated from audio may comprise phonetic symbols representing the audio, instead of actual text corresponding to the audio.

Computer system 110 determines a quality of the database query based on the occurrences of the measurement terms within the processed text, (operation 308). This quality figure may be determined in any of a wide variety of methods. For example, each term may be given a strength based on the location and frequency of occurrences of the measurement terms within the text of the set of records. These strength terms may be combined to produce a quality term for the overall database query.

Once the quality of the database query is determined, computer system 110 performs an action based on the quality of the database query, (operation 310). This action may take a variety of forms. For example, computer system 110 may automatically modify the database query based on the quality of the database query. Alternatively, computer system 110 may make one or more recommendations to a user based on the quality of the database query. For example, computer system 110 may suggest to the user one or more modifications of the database query, such as the addition of further terms, the modification of existing terms, or the deletion of existing terms. Other actions may include providing the user with the quality of the database query, or other general suggestions, such as: “your query needs more terms,” “you over-use the possibility for ‘avoid’ terms,” “the category is complete as-is,” etc.

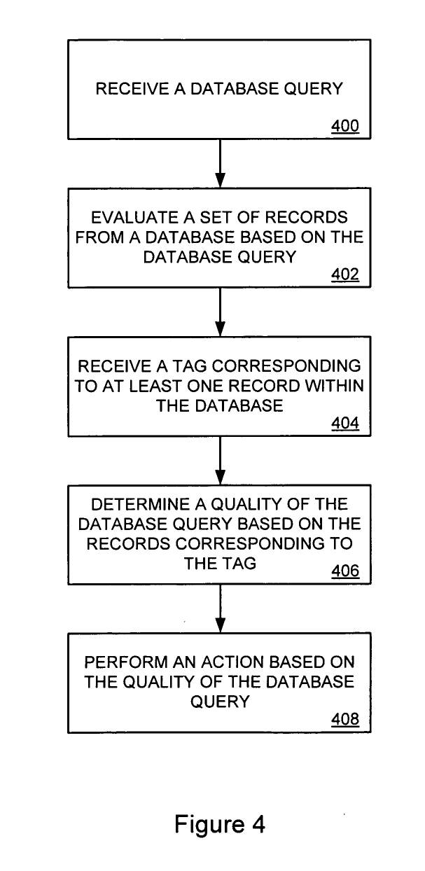

FIG. 4 is a flow diagram illustrating a method for the quality analysis of database queries. Reference numbers from FIG. 4 are indicated parenthetically below. In this example, computer system 110 receives a database query, (operation 400). Computer system 110 then evaluates a set of records from database 108 based on the database query, (operation 402). Computer system 110 also receives a tag corresponding to at least one record within database 108, (operation 404). This tag is used to flag relevant or non-relevant records within database 108. Tags may be created by a user, contained within the database query, or received from any other source. Any quantity of tags may be created, and each tag may take any of a wide variety of formats. For example, tags may comprise Boolean values, numeric values, enumerated type values, or any other data format. Any number of records within database 108 may be tagged as relevant or non-relevant.

Computer system 110 then processes at least one record of the database to determine a quality of the database query based on the records corresponding to the tag, (operation 406). This processing may include finding all the occurrences of a term within one or more records, or determining how many different measurement terms are found within each record, or any other similar processing of the records from database 108. For example, a query that selects a set of records including all of the records tagged as relevant will have a higher quality than a query that fails to select one or more of the records tagged as relevant. Likewise, a query that does not select any of the records tagged as non-relevant will have a higher quality than a query that selects one or more of the records tagged as non-relevant.

Finally, computer system 110 performs an action based on the quality of the database query, (operation 408). As discussed above, this action may take any of a wide variety of forms, including, but not limited to, modifying the database query, or suggesting modifications of the database query to a user.

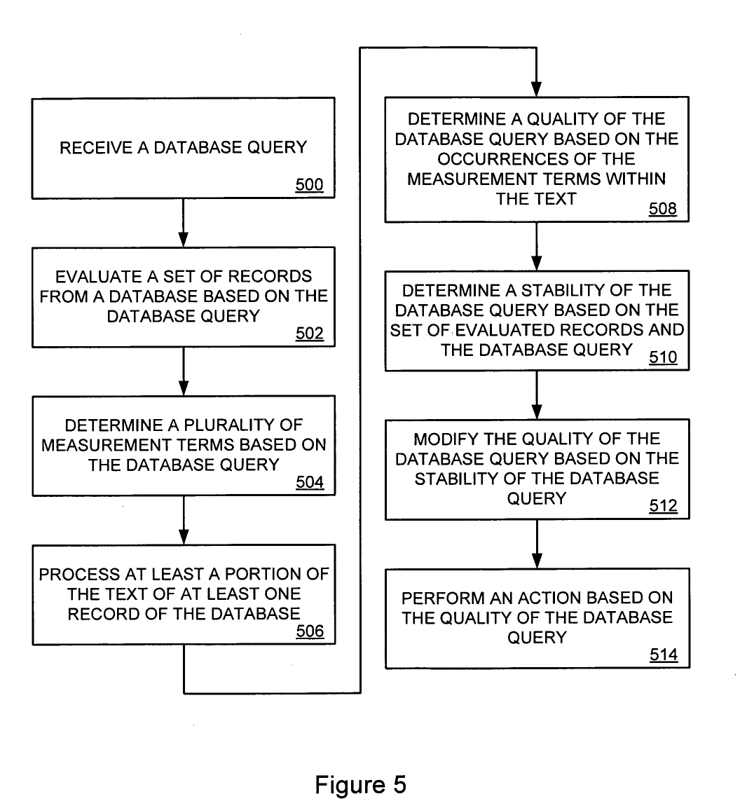

FIG. 5 is a flow diagram illustrating a method for the quality analysis of database queries. Reference numbers from FIG. 5 are indicated parenthetically below. In this example, computer system 110 receives a database query, (operation 500). Computer system 110 then evaluates a set of records from database 108 based on the database query, (operation 502). Computer system 110 determines a plurality of measurement terms based on the database query, (operation 504).

Computer system 110 then processes at least a portion of the text of at least one record of the database, (operation 506). This processing may include finding all the occurrences of a term within one or more records, or determining how many different measurement terms are found within each record, or any other similar processing of the records from database 108. Computer system 110 determines a quality of the database query based on the occurrences of the measurement terms within the processed text, (operation 508).

Computer system 110 also determines a stability of the database query based on the set of evaluated records and the database query, (operation 510). Stability of a database query may be determined using any of a wide variety of methods. When a large number of records are selected by the database query by a single term, the query is said to be unstable. Ideally, each record selected for inclusion in the evaluated set of records will be selected for inclusion by at least two terms in the query. This provides a higher level of confidence that the query is selecting all of the relevant records for inclusion in the evaluated set of records.

Computer system 110 modifies the quality of the database query based on the stability of the database query, (operation 512). Since stable queries are desirable, such queries are of higher quality than unstable queries, and the quality of the database query is modified accordingly.

Finally, computer system 110 performs an action based on the quality of the database query, (operation 514). As discussed above, this action may take any of a wide variety of forms, including, but not limited to, modifying the database query, or suggesting modifications of the database query to a user. For example, if the database query is unstable, computer system 110 may add additional terms to the query, or suggest to the user that additional terms are necessary to create a stable database query.

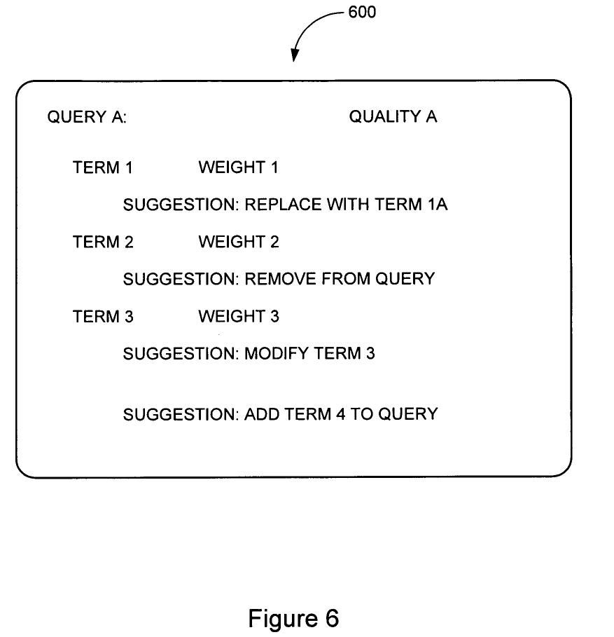

FIG. 6 is an illustration of a user interface 600 in a system for the quality analysis of database queries. This example user interface 600 of the computer system 110 is representative of the type of information that may be provided to a user, but any other interface may be used in other embodiments. In this example user interface 600, the title of the query (QUERY A) and the quality of the query (QUALITY A) are prominently displayed at the top of the screen. In this simple example, the query contains three terms (TERM 1, TERM 2, and TERM 3). Each term has a weight (WEIGHT 1, WEIGHT 2, and WEIGHT 3). Here, the system has made three suggestions to a user. First, under TERM 1, the method has suggested replacing TERM 1 with TERM 1A. The system has also suggested removing TERM 2 from the query. The system has also suggested that the user should modify TERM 3. Finally, the system has suggested adding TERM 4 to the query. Other embodiments may user other user interfaces to communicate quality of a database query to a user, and to perform other actions based on the quality of the database query.

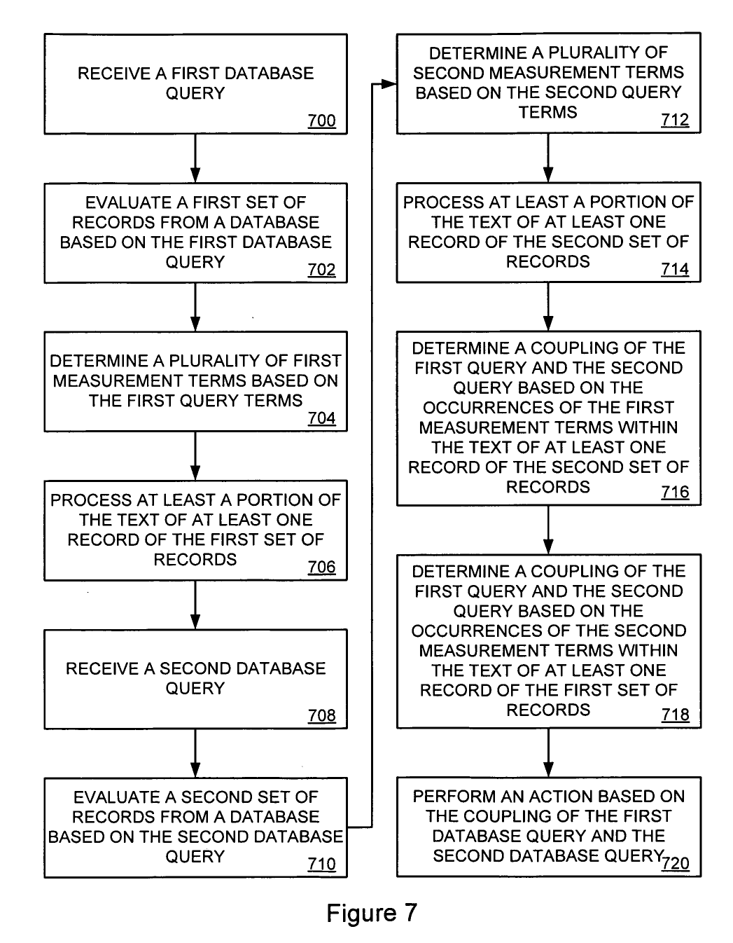

FIG. 7 is a flow diagram illustrating a method for the quality analysis of database queries. Reference numbers from FIG. 7 are indicated parenthetically below. Quality assessment of database queries may also be useful in a root cause analysis (RCA) of database records. In a RCA two or more different queries are created to correspond to different sets of records within database 108. Ideally, each query corresponds to a unique subset of records within database 108. Thus, it is useful to determine a quality for each of the queries, and also to determine the interactions of the sets of records evaluated by each database query. For example, two different queries that evaluate identical sets of records are redundant. Also queries that evaluate very similar sets of records are most likely of little value in a root cause analysis. By determining the quality of each database query and additionally determining the coupling between the database queries, the root cause analysis may be configured to automatically determine which queries are meaningful to the user. This functionality may also be of use in other situations, such as in a system configured to automatically detect when a newly created query is converging towards a previously defined query. In this case, the system may alert the user to the presence of the previously defined query, saving the user unnecessary effort.

In this example, computer system 110 receives a first database query, (operation 700). Computer system 110 then evaluates a first set of records from database 108 based on the first database query, (operation 702). Optionally, computer system 110 determines a plurality of first measurement terms based on the first database query, (operation 704). Computer system 110 then processes at least a portion of the text of at least one record of the first set of records, (operation 706).

Computer system 110 also receives a second database query, (operation 708). Optionally, computer system 110 then evaluates a second set of records from database 108 based on the second database query, (operation 710). Computer system 110 determines a plurality of second measurement terms based on the second database query, (operation 712). Optionally, computer system 110 then processes at least a portion of the text of at least one record of the second set of records, (operation 714).

Computer system 110 determines a coupling of the first query and the second query based on the occurrences of the first measurement terms within the text of at least one record of the second set of records, (operation 716). Computer system 110 optionally determines the coupling of the first query and the second query based on the occurrences of the second measurement terms within the text of at least one record of the first set of records, (operation 718).

Finally, computer system 110 performs an action based on the coupling of the first database query and the second database query, (operation 720). This action may take any of a variety of forms. For example, within a root cause analysis, the method may delete queries that are highly coupled, and thus redundant. The method may make recommendations to a user about modifying the set of queries based on the coupling of the existing queries. Note that this method may be utilized for some or all of the queries used in a root cause analysis. There is no requirement to determine couplings for all of the possible pairs of queries, but some embodiments may determine the full set of possible couplings in the course of a root cause analysis.

One should note that the flowcharts included herein show the architecture, functionality, and/or operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions (such as depicted in the flowcharts), can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non-exhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

It should be emphasized that the above-described embodiments are merely possible examples of implementations, merely set forth for a clear understanding of the principles of this disclosure. Many variations and modifications may be made to the above-described embodiments without departing substantially from the spirit and principles of the disclosure. All such modifications and variations are intended to be included herein within the scope of this disclosure.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method for analyzing a database query comprising:
receiving a database query;
evaluating a set of records from a database based on the database query, the database comprising a plurality of records, each record comprising text translated from audio;
determining a plurality of measurement terms based on the database query;
processing at least a portion of the text of at least one record of the database to determine a quality of the database query based on the occurrences of the measurement terms within the portion of text; and
performing an action based on the quality of the database query.

2. The method for analyzing a database query of claim 1, wherein the measurement terms comprise terms from the database query.

3. The method for analyzing a database query of claim 1, wherein the measurement terms comprise synonyms, homophones, and alternate inflections of terms from the database query.

4. The method analyzing a database query of claim 1, wherein processing at least a portion of the text of at least one record of the database further comprises:
processing at least a portion of the text of at least one record of the database to determine the quality of the database query based on the location and frequency of the measurement terms alone and with respect to each other occurring within the text.

5. The method for analyzing a database query of claim 1, wherein at least one record includes a confidence score corresponding to the confidence of the translation of the portion of the text from audio to text.

6. The method for analyzing a database query of claim 5, wherein processing at least a portion of the text of at least one record of the database further comprises:
processing at least a portion of the text of at least one record of the database to determine the quality of the database query based on the confidence score of the at least a portion of text.

7. The method for analyzing a database query of claim 1, further comprising:
processing the set of records with the database query to determine a stability of the database query; and
modifying the quality of the database query based on the stability of the database query.

8. The method for analyzing a database query of claim 1, wherein at least one record also includes metadata.

9. The method for analyzing a database query of claim 1, further comprising:
processing at least a portion of the metadata of at least one record of the database to determine a quality of the database query.

10. The method for analyzing a database query of claim 1, wherein the action includes modifying the database query.

11. The method for analyzing a database query of claim 1, wherein the action includes suggesting modification of the database query to a user.

12. The method for analyzing a database query of claim 1, wherein evaluating a set of records from the database includes determining a score for each record based on the occurrences of the measurement terms within each record.

13. The method for analyzing a database query of claim 1, wherein the text comprises phonetic symbols.

14. A method for analyzing a database query comprising:
receiving a first database query;
evaluating a first set of records from a database based on the first database query, the database comprising a plurality of records, each record comprising text translated from audio;
receiving a second database query;
determining a plurality of second measurement terms based on the second database query;
processing at least a portion of the text of at least one record of the first set of records to determine a coupling of the first database query and the second database query based on the occurrences of the second measurement terms within the portion of the text of at least one record of the first set of records; and
performing an action based on the coupling of the first database query and the second database query.

15. The method for analyzing a database query of claim 14, further comprising:
determining a plurality of first measurement terms based on the first database query;
evaluating a second set of records from the database based on the second database query; and
processing at least a portion of the text of at least one record of the second set of records to further determine the coupling of the first database query and the second database query based on the occurrences of the first measurement terms within the portion of the text of at least one record of the second set of records.

16. The method for analyzing a database query of claim 15, further comprising:
processing at least a portion of the text of at least one record of the database to determine a quality of the first database query based on the occurrences of the first measurement terms within the portion of text; and
processing at least a portion of the text of at least one record of the database to determine a quality of the second database query based on the occurrences of the second measurement terms within the portion of text; and
performing an action based on the quality of the first database query and the quality of the second database query.

17. A computer-readable medium having instructions stored thereon for operating a computer system, wherein the instructions, when executed by the computer system, direct the computer system to:
receive a database query;
evaluate a set of records from a database based on the database query, the database comprising a plurality of records, each record comprising text translated from audio;
determine a plurality of measurement terms based on the query;
process at least a portion of the text of at least one record of the database to determine a quality of the database query based on the occurrences of the measurement terms within the portion of text; and
perform an action based on the quality of the database query.

18. The computer-readable medium of claim 17, wherein the instructions, when executed by the computer system, further direct the computer system to:
process at least a portion of the text of at least one record of the database to determine the quality of the database query based on the location and frequency of the measurement terms alone and with respect to each other occurring within the text.

19. The computer-readable medium of claim 17, wherein at least a portion of the text within a record includes a confidence score corresponding to the confidence of the translation of the portion of the text from audio to text.

20. The computer-readable medium of claim 19, wherein the instructions, when executed by the computer system, further direct the computer system to:
process at least a portion of the text of at least one record of the database to determine the quality of the database query based on the confidence score of the at least a portion of text.

21. The computer-readable medium of claim 17, wherein the instructions, when executed by the computer system, further direct the computer system to:
process the set of records with the query to determine a stability of the database query; and
modify the quality of the database query based on the stability of the database query.

22. A computer system comprising:
a storage system containing software; and
a processing system coupled to the storage system;
wherein the processing system is instructed by the software to:
receive a database query;
evaluate a set of records from a database based on the database query, the database comprising a plurality of records, each record comprising text translated from audio;
determine a plurality of measurement terms based on the database query;
process at least a portion of the text of at least one record of the database to determine a quality of the database query based on the occurrences of the measurement terms within the portion of text; and
perform an action based on the quality of the database query.

23. The computer system of claim 22, wherein the processing system is further instructed by the software to:
process at least a portion of the text of at least one record of the database to determine the quality of the database query based on the location and frequency of the measurement terms alone and with respect to each other occurring within the text.

24. The computer system of claim 22, wherein at least a portion of the text within a record includes a confidence score corresponding to the confidence of the translation of the portion of the text from audio to text.

25. The computer system of claim 24, wherein the processing system is further instructed by the software to:
process at least a portion of the text of at least one record of the database to determine the quality of the database query based on the confidence score of the at least a portion of text.
